(19) United States
(12) Patent Application Publication
(10) Pub. No.: US 2013/0281578 A1
(43) Pub. Date: Oct. 24, 2013

(54) SEPARATING APPARATUS FOR SEPARATING RIND AND PITH OF A STALK METHOD FOR PLASTICIZING AND GRANULATING CORTICAL FIBER OF THE STALK

(71) Applicant: CHANGCHUN YUANYANG PLASTIC PRODUCTS CO., LTD., Changchun City (CN)

(72) Inventors: Roger Jiang, Changchun City (CN); Qingwen Wang, Changchun City (CN)

(73) Assignee: Changchun Yuanyang Plastic Products Co., Ltd., Changchun City (CN)

(21) Appl. No.: 13/761,991

(22) Filed: Feb. 7, 2013

(30) Foreign Application Priority Data
Apr. 19, 2012 (CN) 201210116804.9

(51) Int. Cl. A01F 7/02

(52) U.S. Cl. CPC A01F 7/02
USPC 524/9; 460/150; 460/16

(57) ABSTRACT

A separating apparatus for separating rind and pith of a stalk including: a working platform; a support frame connected to the working platform; a saw blade disposed on the working platform for gradually splitting the stalk in a longitudinal direction thereof with the movement of the stalk; a guiding member disposed on the working platform and located behind the saw blade for separating the stalk that is split; a brush located behind the guiding member and protruded from the working platform, the brush being connected to the support frame through a brush shaft, and an axis of the brush shaft being perpendicular to the stalk; and a first motor connected to the brush shaft for driving the brush shaft to rotate. A method for plasticizing and granulating cortical fiber of a stalk based on the above separating apparatus for separating rind and pith of the stalk is also disclosed.

### CROSS-REFERENCE TO RELATED APPLICATIONS

This application claims the benefit of priority to Chinese Patent Application No. 201210116804.9 filed on Apr. 19, 2012, which is herein incorporated by reference.

### BACKGROUND OF THE INVENTION

1. Field of the Invention

The present application relates to a technical field of separating apparatus for separating rind and pith of corn stalk, more specifically, to a separating apparatus for separating rind and pith of a stalk and a method for plasticizing and granulating cortical fiber of the stalk.

2. Description of the Related Art

The corn is one of the crops planted in large areas in north China. In the traditional agriculture, corn stalks are generally used for rural fuels and livestock feeds. With the continuous improvement of the living standards of farmers, corn stalks are gradually no longer used, and are generally discarded or burned, resulting in pollution of the environment and energy waste. In order to avoid environmental pollution and waste of energy, the plasticizing and granulating of the corn stalk is one of the effective ways of reusing the stalk.

In the course of plasticizing and granulating the corn stalk, the corn stalk material is pressed or hot pressed at a temperature up to around 160 degree Celsius. Since the pith in the middle portion of the corn stalk contains sugar and cellulose which are easy to be carbonized where mixed with plastic at a high temperature, therefore it is hard to obtain a qualified granular material. Thereby, only the cortical fiber of the corn stalk can be used in the plasticizing and granulating process, that is, it requires removing the pith in the corn stalk before the plasticizing and granulating process.

Currently, the rind and the pith of the stalk is mainly separated manually, so as to remove the pith in the middle portion of the corn stalk, which requires a long time for separating the rind and the pith of the stalk, thereby the efficiency of separating the rind and the pith of the stalk is low.

In addition, it requires a large number of manpower if separating the rind and the pith of the stalk manually, which results in a high cost for obtaining the cortical fiber of the stalk, and it is not good for the popularization and mass production of the plasticizing and granulating of cortical fiber of the stalk.

In summary, there is an urgent demand for the person skilled in the art to provide a separating apparatus for separating rind and pith of a stalk, to reduce the time required for the separating of the rind and the pith of the stalk, and thus to improve the efficiency of separating the rind and the pith of the stalk.

### SUMMARY OF THE INVENTION

In view of this, it is provided according to the present application a separating apparatus for separating rind and pith of a stalk, which reduces the time required for the separating of the rind and the pith of the stalk, and thus improves the efficiency of separating the rind and the pith of the stalk.

To achieve the above object, it is provided according to the present application the following technical solutions.

A separating apparatus for separating rind and pith of a stalk including:

a working platform;

a support frame connected to the working platform;

a saw blade disposed on the working platform for gradually splitting the stalk in a longitudinal direction thereof with the movement of the stalk;

a guiding member disposed on the working platform and located behind the saw blade for separating the stalk that is split;

a brush located behind the guiding member and protruded from the working platform, the brush being connected to the support frame through a brush shaft, and an axis of the brush shaft being perpendicular to the stalk; and

a first motor connected to the brush shaft for driving the brush shaft to rotate.

Preferably, in the above separating apparatus for separating rind and pith of the stalk, the saw blade is perpendicular to the working platform and penetrates through the working platform; and the first motor is further connected to the saw blade for driving the saw blade to rotate within a plane perpendicular to the working platform.

Preferably, in the above separating apparatus for separating rind and pith of the stalk, the guiding member is arranged to be collinear with the saw blade.

Preferably, the above separating apparatus for separating rind and pith of the stalk further includes a pressing roller connected to the support frame for restricting an upward jumping of the stalk, the pressing roller being located above the brush.

Preferably, the above separating apparatus for separating rind and pith of the stalk further includes a feed chute located on the working platform and in front of the saw blade, the feed chute being arranged to be collinear with the saw blade.

Preferably, in the above separating apparatus for separating rind and pith of the stalk, the feed chute is abutted on the working platform and is connected to the support frame through a first compression spring.

Preferably, in the above separating apparatus for separating rind and pith of the stalk, there are at least two saw blades, and said saw blades are arranged in parallel on the working platform; and the number of the guiding member and the number of the brush are the same as that of the saw blades.

Preferably, the above separating apparatus for separating rind and pith of the stalk further includes: an upper feed roller, a lower feed roller, an upper discharge roller and a lower discharge roller, each of which being arranged perpendicular to the stalk. The upper feed roller and the upper discharge roller are located at a top portion of the working platform, and the lower feed roller and the lower discharge roller are protruded out of a surface of the working platform; and

a second motor for driving the upper feed roller and the lower feed roller to rotate in opposite directions and driving the upper discharge roller and the lower discharge roller to rotate in opposite directions.

Preferably, in the above separating apparatus for separating rind and pith of the stalk, the upper feed roller is connected to the support frame via a corresponding second compression spring, and the upper discharge roller is connected to the support frame via a corresponding second compression spring.

It is further provided according to the present application a method for plasticizing and granulating cortical fiber of a stalk based on the above separating apparatus for separating rind and pith of the stalk, including:

1) separating rind and pith of a stalk by the above separating apparatus for separating rind and pith of the stalk to obtain cortical fiber of the stalk;

2) pulverizing the cortical fiber by a pulverizer to obtain cortical fiber powders;

3) selecting cortical fiber powders having particle diameters between 20-150 meshes by the pulverizer;

4) drying the selected cortical fiber powders by a drier;

5) putting a processing aid and a thermoplastic plastic, together with the dried cortical fiber powders, into a mixing machine, and mixing the same at a set mixing temperature for a set mixing time to obtain a mixed material; and

6) melt-mixing and granulating the mixed material by a granulator at a set temperature to obtain composite material grains.

A working process of the separating apparatus for separating rind and pith of the stalk according to embodiments of the present application is as follow.

A stalk is placed on the working platform and is fed along the longitudinal direction of the stalk, such that the stalk is passed through the saw blade and is gradually split, by the saw blade, from the bottom side of the stalk along the longitudinal direction thereof; then the stalk split by the saw blade is passed through the guiding member, such that the stalk is separated along the slit split by the saw blade, and that the pith in the stalk is exposed; finally, the first motor is actuated to drive the brush shaft to rotate, therefore the brush connected to the brush shaft is rotated together with the brush shaft, then the stalk that has been separated is passed through the rotating brush such that the exposed pith is brushed away, thereby achieving the separation of the rind and the pith of the stalk.

As can be seen from the above working process, the separating apparatus for separating rind and pith of the stalk according to the embodiments of the present application achieves the separation of the pith and the rind of the stalk with a mechanical apparatus, Compared with the prior manner in which the pith and the rind of the stalk are separated manually, it is apparent that the separating apparatus according to the present application effectively reduces the time required for separating the pith and the rind of the stalk, thereby improving the efficiency of separating the pith and the rind of the stalk. Meanwhile with the separating apparatus for separating rind and pith of the stalk, the demands for manpower is reduced, and the manpower cost is reduced effectively, thereby the cost for obtaining cortical fiber of stalk is reduced, and it facilitates the popularization and mass production of the plasticizing and granulating of the cortical fiber of the stalk.

### BRIEF DESCRIPTION OF THE DRAWINGS

In order to clearly illustrate embodiments of the present application or technical solutions in the prior art, drawings used in the descriptions of the embodiments or the prior art will be described briefly hereinafter. Apparently, the drawings in the following description are only some embodiments of the present application, and those skilled in the art can also obtain other drawings based on these drawings without any creative work.

FIG. 1 is a structural schematic view of a separating apparatus for separating rind and pith of a stalk according to an embodiment of the present application;

FIG. 2 is a partial structural schematic view of a separating apparatus for separating rind and pith of a stalk according to an embodiment of the present application; and

FIG. 3 is a schematic flow chart of a method for plasticizing and granulating cortical fiber of a stalk according to an embodiment of the present application.

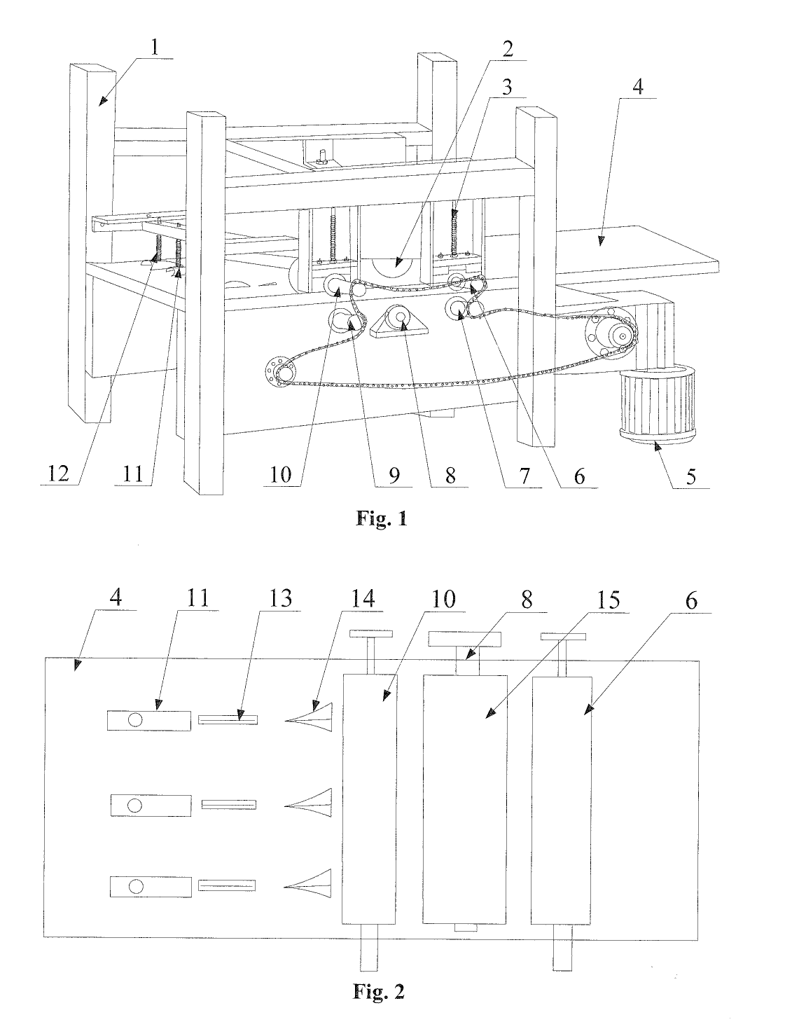

### REFERENCE NUMERALS IN FIGS. 1 AND 2:

1. support frame; 2. pressing roller; 3. second compression spring;
4. working platform; 5. second motor; 6. upper discharge roller;
7. lower discharge roller; 8. brush shaft; 9. lower feed roller;
10. upper feed roller; 11. feed chute; 12. first compression spring;
13. saw blade; 14. guiding member; 15. brush.

### DETAILED DESCRIPTION

It is provided according to an embodiment of the present application a separating apparatus for separating rind and pith of a stalk, which reduces the time required for separating the rind and the pith of the stalk, thereby improving the efficiency of separating the rind and the pith of the stalk.

Technical solutions in the embodiments of the present application will be described clearly and completely hereinafter in conjunction with the accompanying drawings in the embodiments of the present application. Apparently, the embodiments described hereinafter are only a part of the embodiments of the present application, rather than all of the embodiments. All other embodiments obtained by those skilled in the art, based on the embodiments in the present application, without any creative work should be considered as falling into the protection scope of the present application.

Referring to FIGS. 1 and 2, FIG. 1 is a structural schematic view of a separating apparatus for separating rind and pith of a stalk according to an embodiment of the present application, and FIG. 2 is a partial structural schematic view of a separating apparatus for separating rind and pith of a stalk according to an embodiment of the present application.

The separating apparatus for separating rind and pith of a stalk according to an embodiment of the present application includes: a working platform 4; a support frame 1 connected to the working platform 4; a saw blade 13 disposed on the working platform 4 for gradually splitting the stalk along the longitudinal direction of the stalk with the movement of the stalk; a guiding member 14 disposed on the working platform 4 and located behind the saw blade 13 for separating the stalk that is split; a brush 15 located behind the guiding member 14 and protruded from the working platform 4, the brush 15 is connected to the support frame 1 through a brush shaft 8, and the axis of the brush shaft 8 is perpendicular to the stalk; and a first motor connected to the brush shaft 8 and driving the brush shaft 8 to rotate.

The working process of the separating apparatus for separating rind and pith of the stalk according to the embodiment of the present application is as follow.

A stalk is placed on the working platform 4 and is fed along the longitudinal direction of the stalk, such that the stalk is passed through the saw blade 13 and is gradually split from the bottom side of the stalk along the longitudinal direction thereof by the saw blade 13; then the stalk split by the saw blade 13 is passed through the guiding member 14 such that the stalk is separated along the slit split by the saw blade 13, and that the pith in the stalk is exposed; finally, the first motor is actuated to drive the brush shaft 8 to rotate, therefore the brush 15 connected to the brush shaft 8 is rotated together with the brush shaft 8, then the separated stalk is passed through the rotating brush 15 such that the exposed pith is brushed away, thereby achieving the separation of the rind and the pith of the stalk.

As can be seen from the above working process, the separating apparatus for separating rind and pith of the stalk according to the embodiment of the present application achieves the separation of the pith and the rind of the stalk with a mechanical apparatus. Compared with the prior manner in which the pith and the rind of the stalk are separated manually, it is apparent that the separating apparatus according to the present application effectively reduces the time required for separating the pith and the rind of the stalk, thereby improving the efficiency of separating the pith and the rind of the stalk. Meanwhile with the separating apparatus for separating rind and pith of the stalk, the demands for manpower is reduced, and the manpower cost is reduced effectively, thereby the cost for obtaining cortical fiber of the stalk is reduced, and it facilitates the popularization and mass production of the plasticizing and granulating of the cortical fiber of the stalk.

In the separating apparatus for separating rind and pith of the stalk according to the above embodiment, the guiding member 14 may have various shapes, such as a cymbiform shape, a prism shape or a pyramidal shape. Preferably, the guiding member 14 has a triangular pyramid shape to save the material used for the guiding member 14, and thus to reduce the cost. In order that the guiding member 14 can gradually separate the stalk such that the pith of the stalk is exposed outside, preferably, the guiding member 14 has a triangular pyramid shape which has arc-shaped edges, and the edges are protruded upwards. In this way, the guiding member 14 can come into contacts with the inside of the stalk gradually, and gradually separate the stalk, thereby the stalk can be separated completely relatively, such that all of the pith can be exposed outside, which provides a good precondition for the brush 15 to brush the pith away subsequently, and thus it is relatively easy for the brush 15 to brush the pith away.

Preferably, in the separating apparatus for separating rind and pith of the stalk according to the above embodiment, the guiding member 14 is made of hardwood, metal or rigid plastic, the brush 15 is made of metal, and preferably is made of steel, which materials are easily available and have low costs. The materials of the guiding member 14 and the brush 15 are not limited in the embodiments of the present application, as long as they can perform corresponding functions.

In order to ensure that the saw blade 13 can split the stalk quickly, in the separating apparatus for separating rind and pith of the stalk according to the above embodiment, the saw blade 13 is perpendicular to the working platform 4 and penetrates through the working platform 4; the first motor is further connected to the saw blade 13 for driving the saw blade 13 to rotate within a plane perpendicular to the working platform 4. In this way, the saw blade 13 is driven, by the first motor, to rotate at a high speed, which facilitates the splitting of the stalk, improves the efficiency of the separating of the rind and the pith of the stalk, and further increases the production efficiency of the plasticizing and granulating of the stalk; meanwhile, the splitting quality of the saw blade 13 is increased. Furthermore, since the saw blade 13 is driven by the first motor to rotate, the number of the motor is reduced. Thereby the cost of the separating apparatus for separating rind and pith of the stalk is reduced. Apparently, the saw blade 13 may be driven to rotate by other motors. The motor by which the saw blade 13 is driven is not limited in the embodiment of the present application. In order to facilitate the stalk to pass through the saw blade 13 as well as to facilitate the saw blade 13 to split the stalk, preferably, the guiding member 14 is arranged to be collinear with the saw blade 13, which can facilitate the guiding member 14 to separate the stalk that has been split, thereby the efficiency of the separating of the rind and the pith of the stalk is improved.

In the separating apparatus for separating rind and pith of the stalk according to the above embodiment, where the brush 15 is brushing pith, it is inevitable that the stalk may jump towards the direction away form the brush 15, that is the stalk may jump upwards, which will affect the brushing of the brush, and thus a longer time for the brushing is required. In order to prevent the stalk from jumping upwards, the above separating apparatus for separating rind and pith of the stalk further includes a pressing roller 2 connected to the support frame 1 for restricting the upward jumping of the stalk. The pressing roller 2 is located above the brush 15. In this way, the pressing roller 2 can restrict the upward jumping, that is, the jumping towards the direction away form the brush 15, of the stalk, which ensures that the brush 15 can brush away the pith normally, and thus the efficiency that the pith is brushed away is increased. The shape and the size of the pressing roller 2 are not limited in the embodiment of the present application. In practice, the diameters of the stalks are different, in order that the above separating apparatus for separating rind and pith of the stalk is applicable to stalks having different diameters, the distance between the pressing roller 2 and the brush 15 is adjustable, that is, the pressing roller 2 can be moved up and down in the vertical plane, preferably, the mounting end of the pressing roller 2 is rotatably provided in a mounting hole of the support frame 1, the mounting hole may be a stripe-shaped hole, and the mounting end of the pressing roller 2 not only can be rotated in the stripe-shaped hole but also can be moved up and down along the direction that the stripe-shaped hole is extended.

In order to facilitate the stalk to pass through the saw blade 13, the above separating apparatus for separating rind and pith of the stalk further includes a feed chute 11 located on the working platform 4 and in front of the saw blade 13, the feed chute 11 is arranged to be collinear with the saw blade 13. The stalk can be inserted in the feed chute 11 directly and then is pushed, to thereby prevent the stalk from moving towards the two sides of the working platform 4, which facilitates the stalk to pass through the saw blade 13, and improves the efficiency of the separating of the rind and the pith of the stalk. The feed chute 11 may have a square shape, or an arch shape. The shape and the size of the feed chute 11 are not limited in the embodiment of the present application. In practice, the diameters of the stalks are different, in order that the above separating apparatus for separating rind and pith of the stalk is applicable to stalks having different diameters, in the above separating apparatus for separating rind and pith of the stalk, the feed chute 11 may be configured to be relative large. Preferably, the feed chute 11 is abutted on the working platform 4 and is connected to the support frame 1 through a first compression spring 12. The feed chute 11 is connected to the working platform 4 under the compression spring force of the first compression spring 12. In a case that the diameter of the stalk to be separated is large, the stalk pushes the feed chute upwards, the feed chute 11 can be moved upwards under the combined action of the force applied by stalk and the force applied by the spring, such that the stalk can be inserted in the feed chute 11. In this way, the feed chute 11 is applicable to stalks having different diameters. In order to prevent the first compression spring 12 from bent, a guide shaft may be arranged in the first compression spring, one end of the guide shaft is connected to the feed chute 11, and the other end thereof passes through a guide hole on the support frame 1. Where the first compression spring 12 moves upwards, the guide shaft moves upwards along the guide hole, thereby the first compression spring 12 is prevented from being bent.

In order to improve the efficiency of the separating of the rind and the pith of the stalk, in the above separating apparatus for separating rind and pith of the stalk according to the above embodiment, there are at least two saw blades 13, and the saw blades 13 are arranged in parallel on the working platform 4; the number of the guiding member 14 and the number of the brush 5 are the same as that of the saw blade 13. The number of the saw blade 13 is adjustable based on the size of the working platform 4 and the required efficiency of the separating of the rind and the pith, which is not limited in the embodiment of the present application.

In order to further improve the efficiency of the separating of the rind and the pith of the stalk, the above separating apparatus for separating rind and pith of the stalk further includes: an upper feed roller 10, a lower feed roller 9, an upper discharge roller 6 and a lower discharge roller 7, each of which is arranged perpendicular to the stalk, the upper feed roller 10 and the upper discharge roller 6 are located at the top portion of the working platform 4, and the lower feed roller 9 and the lower discharge roller 7 are protruded out of the surface of the working platform 4; and a second motor 5 for driving the upper feed roller 10 and the lower feed roller 9 to rotate in opposite directions and driving the upper discharge roller 6 and the lower discharge roller 7 to rotate in opposite directions. The second motor 5 drives the upper feed roller 10 and the lower feed roller 9 to rotate in the opposite directions, therefore achieving the feeding of the stalk; the second motor 5 drives the upper discharge roller 6 and the lower discharge roller 7 to rotate in the opposite directions, therefore achieving the discharging of the stalk. In the above separating apparatus for separating rind and pith of the stalk, an automatic conveying of the stalk is achieved through the second motor 5, the upper feed roller 10, the upper discharge roller 6, the lower feed roller 9 and the lower discharge roller 7, which reduces the requirement for manpower and the cost required for the separating of the rind and the pith, thereby reducing the cost for the plasticizing and granulating of the stalk. Meanwhile, the efficiency of the separating of the rind and the pith of the stalk is improved.

In practice, the diameters of the stalks are different, in order that the above separating apparatus for separating rind and pith of the stalk is applicable to stalks having different diameters, in the above separating apparatus for separating rind and pith of the stalk, the upper feed roller 10 and the upper discharge roller 6 are connected to the support frame 1 via corresponding second compression springs 3, respectively. In this way, the distance between the upper feed roller 10 and the lower feed roller 9 and the distance between the upper discharge roller and the lower discharge roller 7 are adjustable, thereby the above separating apparatus for separating rind and pith of the stalk is applicable to stalks having different diameters.

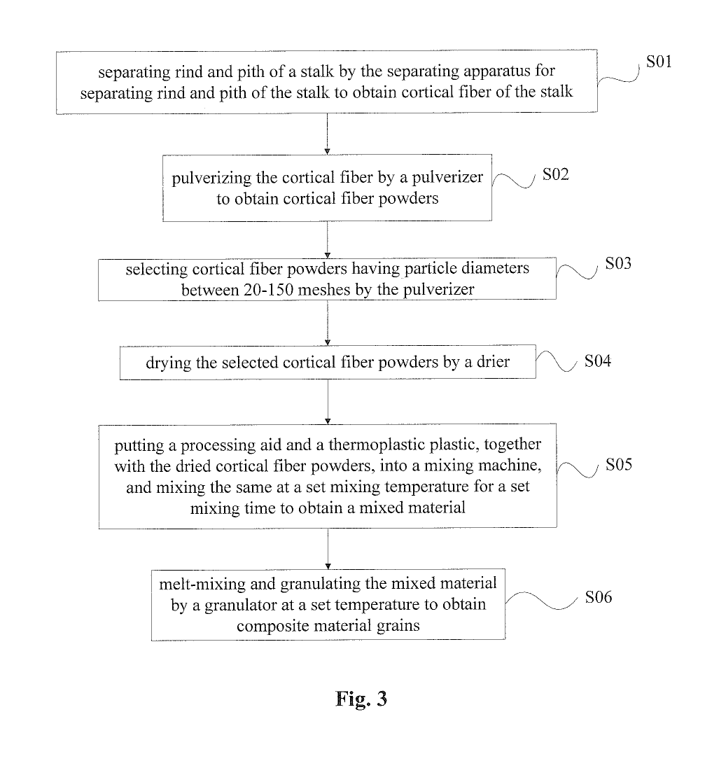

Based on the separating apparatus for separating rind and pith of the stalk according to the above embodiment, it is further provided a method for plasticizing and granulating cortical fiber of a stalk according to an embodiment of the present application, as shown in FIG. 3, the method includes the following steps.

S01) separating the rind and the pith of the stalk by the above separating apparatus for separating rind and pith of the stalk to obtain the cortical fiber of the stalk.

The rind and the pith of the stalk is separated by the separating apparatus for separating the rind and the pith of the stalk, thereby achieving the rind of the stalk, that is, the cortical fiber of the stalk.

S02) pulverizing the cortical fiber by a pulverizer to obtain cortical fiber powders.

S03) selecting cortical fiber powders having particle diameters between 20-150 meshes by the pulverizer.

S04) drying the selected cortical fiber powders by a drier.

The cortical fiber powders is dried by the drier, the moisture contents of the cortical fiber powders are generally required to be smaller than 2%.

S05) putting a processing aid and a thermoplastic plastic, together with the dried cortical fiber powders, into a mixing machine, and mixing them at a set temperature for a set time to obtain a mixed material.

Generally, the processing aid includes: a compatiblizer, a coupling agent, an ultraviolet screening agent, an antioxidant, a lubricant and a toner. Different toners may be selected according to the required color. In order to increase hardness of grains of a composite material, a reinforcing agent such as calcium powder may be added into the processing aid to increase the hardness. The mixing time of the processing aid, the thermoplastic plastic and the cortical fiber powders is generally 20 minutes.

S06) melt-mixing and granulating the mixed material by a granulator at a set temperature to obtain composite material grains.

The mixed material is melt-mixed and granulated by a granulator, the melt-mixing temperature is generally around 160 degree Celsius, and the granulating temperature is generally around 160 degree Celsius. Finally, the required composite material grains are obtained.

The above method for plasticizing and granulating cortical fiber of the stalk is implemented by employing the above separating apparatus for separating rind and pith of the stalk, which improves the efficiency of separating rind and pith of the stalk, thereby increases the production efficiency of the plasticizing and granulating of cortical fiber of the stalk, and facilitates popularization and development of the plasticizing and granulating of cortical fiber of the stalk.

Those skilled in the art can achieve or implement the present application based on the above descriptions of the embodiments herein, and it is apparent that those skilled in the art may make various modifications to the embodiments. The general principle defined herein can be implemented in other embodiments without departing from the spirit or scope of the present application. Therefore, the present application will not be limited to the embodiments described herein, but to be in accordance with the widest scope consistent with the principle and novel features disclosed herein.

1. A separating apparatus for separating rind and pith of a stalk, comprising:
a working platform;
a support frame connected to the working platform;
a saw blade disposed on the working platform for gradually splitting the stalk in a longitudinal direction thereof with the movement of the stalk;
a guiding member disposed on the working platform and located behind the saw blade for separating the stalk that is split;
a brush located behind the guiding member and protruded from the working platform, the brush being connected to the support frame through a brush shaft, and an axis of the brush shaft being perpendicular to the stalk; and
a first motor connected to the brush shaft for driving the brush shaft to rotate.

2. The separating apparatus for separating rind and pith of the stalk according to claim 1, wherein the saw blade is perpendicular to the working platform and penetrates through the working platform; and the first motor is further connected to the saw blade for driving the saw blade to rotate within a plane perpendicular to the working platform.

3. The separating apparatus for separating rind and pith of the stalk according to claim 2, wherein the guiding member is arranged to be collinear with the saw blade.

4. The separating apparatus for separating rind and pith of the stalk according to claim 1, further comprising a pressing roller connected to the support frame for restricting an upward jumping of the stalk, the pressing roller being located above the brush.

5. The separating apparatus for separating rind and pith of the stalk according to claim 1, further comprising a feed chute located on the working platform and in front of the saw blade, the feed chute being arranged to be collinear with the saw blade.

6. The separating apparatus for separating rind and pith of the stalk according to claim 5, wherein the feed chute is abutted on the working platform and is connected to the support frame through a first compression spring.

7. The separating apparatus for separating rind and pith of the stalk according to claim 1, wherein there are at least two saw blades, and said saw blades are arranged in parallel on the working platform; and the number of the guiding member and the number of the brush are the same as that of the saw blades.

8. The separating apparatus for separating rind and pith of the stalk according to claim 7, further comprising: an upper feed roller, a lower feed roller, an upper discharge roller and a lower discharge roller, each of which being arranged perpendicular to the stalk, wherein the upper feed roller and the upper discharge roller are located at a top portion of the working platform, and the lower feed roller and the lower discharge roller are protruded out of a surface of the working platform; and
a second motor for driving the upper feed roller and the lower feed roller to rotate in opposite directions and driving the upper discharge roller and the lower discharge roller to rotate in opposite directions.

8. The separating apparatus for separating rind and pith of the stalk according to claim 8, wherein the upper feed roller is connected to the support frame via a corresponding second compression spring, and the upper discharge roller is connected to the support frame via a corresponding second compression spring.

10. A method for plasticizing and granulating cortical fiber of a stalk, comprising:
1) separating rind and pith of a stalk by the separating apparatus for separating rind and pith of the stalk according to claim 1 to obtain cortical fiber of the stalk;
2) pulverizing the cortical fiber by a pulverizer to obtain cortical fiber powders;
3) selecting cortical fiber powders having particle diameters between 20-150 meshes by the pulverizer;
4) drying the selected cortical fiber powders by a drier;
5) putting a processing aid and a thermoplastic plastic, together with the dried cortical fiber powders, into a mixing machine, and mixing the same at a set mixing temperature for a set mixing time to obtain a mixed material; and
6) melt-mixing and granulating the mixed material by a granulator at a set temperature to obtain composite material grains.

11. A method for plasticizing and granulating cortical fiber of a stalk, comprising:
1) separating rind and pith of a stalk by the separating apparatus for separating rind and pith of the stalk according to claim 2 to obtain cortical fiber of the stalk;
2) pulverizing the cortical fiber by a pulverizer to obtain cortical fiber powders;
3) selecting cortical fiber powders having particle diameters between 20-150 meshes by the pulverizer;
4) drying the selected cortical fiber powders by a drier;
5) putting a processing aid and a thermoplastic plastic, together with the dried cortical fiber powders, into a mixing machine, and mixing the same at a set mixing temperature for a set mixing time to obtain a mixed material; and
6) melt-mixing and granulating the mixed material by a granulator at a set temperature to obtain composite material grains.

12. A method for plasticizing and granulating cortical fiber of a stalk, comprising:
1) separating rind and pith of a stalk by the separating apparatus for separating rind and pith of the stalk according to claim 3 to obtain cortical fiber of the stalk;
2) pulverizing the cortical fiber by a pulverizer to obtain cortical fiber powders;
3) selecting cortical fiber powders having particle diameters between 20-150 meshes by the pulverizer;
4) drying the selected cortical fiber powders by a drier;
5) putting a processing aid and a thermoplastic plastic, together with the dried cortical fiber powders, into a mixing machine, and mixing the same at a set mixing temperature for a set mixing time to obtain a mixed material; and
6) melt-mixing and granulating the mixed material by a granulator at a set temperature to obtain composite material grains.

13. A method for plasticizing and granulating cortical fiber of a stalk, comprising:
1) separating rind and pith of a stalk by the separating apparatus for separating rind and pith of the stalk according to claim 4 to obtain cortical fiber of the stalk;
2) pulverizing the cortical fiber by a pulverizer to obtain cortical fiber powders;
3) selecting cortical fiber powders having particle diameters between 20-150 meshes by the pulverizer;
4) drying the selected cortical fiber powders by a drier;
5) putting a processing aid and a thermoplastic plastic, together with the dried cortical fiber powders, into a mixing machine, and mixing the same at a set mixing temperature for a set mixing time to obtain a mixed material; and
6) melt-mixing and granulating the mixed material by a granulator at a set temperature to obtain composite material grains.

14. A method for plasticizing and granulating cortical fiber of a stalk, comprising:
1) separating rind and pith of a stalk by the separating apparatus for separating rind and pith of the stalk according to claim 5 to obtain cortical fiber of the stalk;
2) pulverizing the cortical fiber by a pulverizer to obtain cortical fiber powders;
3) selecting cortical fiber powders having particle diameters between 20-150 meshes by the pulverizer;
4) drying the selected cortical fiber powders by a drier;
5) putting a processing aid and a thermoplastic plastic, together with the dried cortical fiber powders, into a mixing machine, and mixing the same at a set mixing temperature for a set mixing time to obtain a mixed material; and
6) melt-mixing and granulating the mixed material by a granulator at a set temperature to obtain composite material grains.

15. A method for plasticizing and granulating cortical fiber of a stalk, comprising:
1) separating rind and pith of a stalk by the separating apparatus for separating rind and pith of the stalk according to claim 6 to obtain cortical fiber of the stalk;
2) pulverizing the cortical fiber by a pulverizer to obtain cortical fiber powders;
3) selecting cortical fiber powders having particle diameters between 20-150 meshes by the pulverizer;
4) drying the selected cortical fiber powders by a drier;
5) putting a processing aid and a thermoplastic plastic, together with the dried cortical fiber powders, into a mixing machine, and mixing the same at a set mixing temperature for a set mixing time to obtain a mixed material; and
6) melt-mixing and granulating the mixed material by a granulator at a set temperature to obtain composite material grains.

16. A method for plasticizing and granulating cortical fiber of a stalk, comprising:
1) separating rind and pith of a stalk by the separating apparatus for separating rind and pith of the stalk according to claim 7 to obtain cortical fiber of the stalk;
2) pulverizing the cortical fiber by a pulverizer to obtain cortical fiber powders;
3) selecting cortical fiber powders having particle diameters between 20-150 meshes by the pulverizer;
4) drying the selected cortical fiber powders by a drier;
5) putting a processing aid and a thermoplastic plastic, together with the dried cortical fiber powders, into a mixing machine, and mixing the same at a set mixing temperature for a set mixing time to obtain a mixed material; and
6) melt-mixing and granulating the mixed material by a granulator at a set temperature to obtain composite material grains.

17. A method for plasticizing and granulating cortical fiber of a stalk, comprising:
1) separating rind and pith of a stalk by the separating apparatus for separating rind and pith of the stalk according to claim 8 to obtain cortical fiber of the stalk;
2) pulverizing the cortical fiber by a pulverizer to obtain cortical fiber powders;
3) selecting cortical fiber powders having particle diameters between 20-150 meshes by the pulverizer;
4) drying the selected cortical fiber powders by a drier;
5) putting a processing aid and a thermoplastic plastic, together with the dried cortical fiber powders, into a mixing machine, and mixing the same at a set mixing temperature for a set mixing time to obtain a mixed material; and
6) melt-mixing and granulating the mixed material by a granulator at a set temperature to obtain composite material grains.

18. A method for plasticizing and granulating cortical fiber of a stalk, comprising:
1) separating rind and pith of a stalk by the separating apparatus for separating rind and pith of the stalk according to claim 9 to obtain cortical fiber of the stalk;
2) pulverizing the cortical fiber by a pulverizer to obtain cortical fiber powders;
3) selecting cortical fiber powders having particle diameters between 20-150 meshes by the pulverizer;
4) drying the selected cortical fiber powders by a drier;
5) putting a processing aid and a thermoplastic plastic, together with the dried cortical fiber powders, into a mixing machine, and mixing the same at a set mixing temperature for a set mixing time to obtain a mixed material; and
6) melt-mixing and granulating the mixed material by a granulator at a set temperature to obtain composite material grains.
